(19) United States
(12) Patent Application Publication
(10) Pub. No.: US 2024/0355023 A1
(43) Pub. Date: Oct. 24, 2024

(54) SUPERVISED DATA GENERATION SYSTEM AND SUPERVISED DATA GENERATION METHOD

(71) Applicant: Toyota Jidosha Kabushiki Kaisha, Toyota-shi (JP)

(72) Inventor: Shun SATO, Aichi-gun (JP)

(73) Assignee: TOYOTA JIDOSHA KABUSHIKI KAISHA, Toyota-shi (JP)

(21) Appl. No.: 18/584,257

(22) Filed: Feb. 22, 2024

(30) Foreign Application Priority Data
Apr. 19, 2023 (JP) 2023-068666

(51) Int. Cl. G06T 11/60; G06T 15/04; G06T 15/60; G06T 17/00

(52) U.S. Cl. CPC G06T 11/60; G06T 15/04; G06T 15/60; G06T 17/00

(57) ABSTRACT

The supervised data generation system according to the present disclosure includes a shape information acquisition unit that acquires shape information recording the shape of a target object, an image generation condition setting unit that sets image generation conditions for a simulation image of the target object, and a shape information and an image generation unit that generates a simulation image of a target object and position information of the target object in the simulation image based on image generation conditions; and an image generator that adds position information to the simulation image as annotation information; and a supervised data output unit that outputs a simulation image.

### CROSS-REFERENCE TO RELATED APPLICATION

This application claims priority to Japanese Patent Application No. 2023-068666 filed on Apr. 19, 2023, incorporated herein by reference in its entirety.

### BACKGROUND

### 1. Technical Field

The present disclosure relates to a supervised data generation system and a supervised data generation method.

### 2. Description of Related Art

In recent years, image recognition systems using artificial intelligence (AI) have been attracting attention. In a general image recognition system using artificial intelligence, a learning model is generated by using a large amount of image data and annotation information added to each piece of the image data as supervised data.

The annotation information generally needs to be added manually. That is, when creating the supervised data, a person needs to check each piece of image data and individually add correct annotation information.

For example, Japanese Unexamined Patent Application Publication No. 2018-200685 (JP 2018-200685 A) describes a method for forming a dataset for fully supervised learning, in which supervised data is generated by causing artificial intelligence (AI) trained with weakly supervised data to add annotation information.

### SUMMARY

In the method for forming a dataset for fully supervised learning in JP 2018-200685 A, the artificial intelligence (AI) is caused to add the annotation information. However, the weakly supervised data for training the artificial intelligence (AI) needs to be prepared manually. Therefore, it cannot be said that the generation of supervised data is sufficiently efficient. That is, the technology disclosed in JP 2018-200685 A has a problem in that the efficiency of generation of supervised data cannot be improved sufficiently.

The present disclosure has been made to solve such a problem, and an object of the present disclosure is to provide a supervised data generation system and a supervised data generation method that can improve the efficiency of generation of supervised data.

A supervised data generation system according to one aspect of the present disclosure includes: a shape information acquisition unit configured to acquire shape information indicating a record of a shape of an object; an image generation condition setting unit configured to set an image generation condition for a simulation image of the object; an image generation unit configured to generate the simulation image of the object and position information of the object in the simulation image based on the shape information and the image generation condition; and a supervised data output unit configured to add the position information to the simulation image as annotation information and output the simulation image.

A supervised data generation method according to one aspect of the present disclosure includes: acquiring, by a computer, shape information indicating a record of a shape of an object; setting, by the computer, an image generation condition for a simulation image of the object; generating, by the computer, the simulation image of the object and position information of the object in the simulation image based on the shape information and the image generation condition; adding, by the computer, the position information to the simulation image as annotation information; and outputting, by the computer, the simulation image.

According to the present disclosure, it is possible to provide the supervised data generation system and the supervised data generation method that can improve the efficiency of generation of supervised data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of an image recognition system according to the first embodiment;

FIG. 2 is a block diagram showing the configuration of the supervised data generation system according to the first embodiment;

FIG. 3A is a schematic diagram for explaining the configuration of the image generation unit according to the first embodiment;

FIG. 3B is a schematic diagram for explaining the configuration of the image generation unit according to the first embodiment;

FIG. 3C is a schematic diagram for explaining the configuration of the image generation unit according to the first embodiment;

FIG. 3D is a schematic diagram for explaining the configuration of the image generation unit according to the first embodiment;

FIG. 3E is a schematic diagram for explaining the configuration of the image generation unit according to the first embodiment;

FIG. 4 is a flowchart for explaining the operation of the supervised data generation system according to the first embodiment; and

FIG. 5 is a flowchart for explaining the operation of the image generation unit according to the first embodiment.

### DETAILED DESCRIPTION OF EMBODIMENTS

### First Embodiment

### Configuration of Supervised Data Generation System

Hereinafter, a first embodiment according to the present disclosure will be described in detail with reference to the drawings. First, the configuration of the supervised data generation system according to this embodiment will be explained in detail.

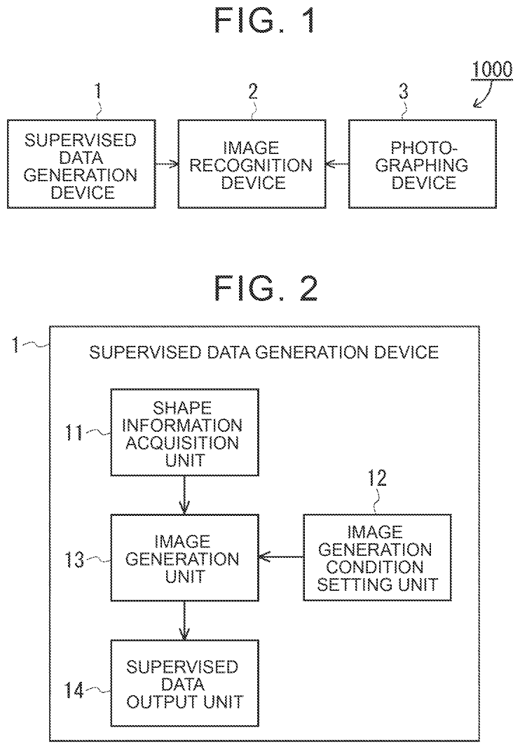

FIG. 1 is a block diagram showing the configuration of an image recognition system according to the first embodiment. More specifically, FIG. 1 is a block diagram showing the configuration of an image recognition system in which a supervised data generation system according to the present embodiment is introduced.

The supervised data generation system according to this embodiment is introduced as a supervised data generation device 1 into an image recognition system 1000 as shown in FIG. 1. The image recognition system 1000 according to this embodiment photographs a specific area and recognizes an object appearing in the photographed image using artificial intelligence (AI). In other words, the image recognition system 1000 is an image recognition system that recognizes whether an object exists within at least a specific area.

For example, the image recognition system 1000 may photograph an area within a factory as a specific area. The image recognition system 1000 may recognize, as objects, workers working in the factory, moving objects patrolling the factory, various devices installed in the factory, manufactured products, and the like. In this case, the image recognition system 1000 may be a system for determining the position of a recognized object.

Further, the image recognition system 1000 may, for example, photograph an area where entry of humans is prohibited as a specific area. Then, the image recognition system 1000 may recognize a person who has entered the area as an object. In this case, the image recognition system 1000 may be a system for monitoring intruders in a restricted area.

Further, the image recognition system 1000 may photograph an area on a road as a specific area, for example. Then, the image recognition system 1000 may recognize a vehicle passing on the road or a pedestrian walking on the road as a target object. In this case, the image recognition system 1000 may be a system for understanding the amount of traffic on the road.

In other words, the image recognition system 1000 according to the present embodiment may set any area as a specific area as long as it is an area where a target object may exist. Further, the image recognition system 1000 according to the present embodiment may recognize any object as a target object as long as it is an object whose shape characteristics can be learned by artificial intelligence. Further, the image recognition system 1000 according to the present embodiment may be used for any purpose as long as there is a need to recognize an object existing within a specific area.

The image recognition system 1000 according to this embodiment includes an image recognition device 2 and a photographing device 3 in addition to the supervised data generation device 1. In other words, the image recognition system 1000 according to this embodiment is composed of three devices.

However, the image recognition system 1000 according to the present disclosure does not necessarily need to be composed of three devices. For example, the image recognition system 1000 according to the present disclosure may be configured with one or two devices. In this case, the image recognition system 1000 may include, for example, one computer device having the functions of the supervised data generation device 1 and the image recognition device 2, and a photographing device.

The photographing device 3 photographs an image of a specific area. The photographing device 3 outputs the photographed image to the image recognition device 2.

The image recognition device 2 acquires a simulation image of an object as supervised data from a supervised data generation device 1, which will be described later. The image recognition device 2 is equipped with artificial intelligence (AI), learns the acquired supervised data, and generates a trained model that is trained to recognize objects appearing in the input image. The image recognition device 2 acquires an image of a specific area from the photographing device 3. The image recognition device 2 uses the generated trained model to recognize an object appearing in the acquired image.

When the image recognition device 2 recognizes a target object, for example, it may record the position of the recognized target object. Further, when the image recognition device 2 recognizes the target object, the image recognition device 2 may, for example, notify the user that the target object has been recognized. Moreover, when the image recognition device 2 recognizes a target object, the image recognition device 2 may record the number of recognized targets, for example.

In other words, the image recognition device 2 may be used for any purpose as long as it has a configuration that recognizes objects that exist within a specific area, and the image recognition device 2 may output recognition results depending on the purpose. The format may be changed as appropriate.

The supervised data generation device 1 according to this embodiment is a device that outputs supervised data to the image recognition device 2. More specifically, the supervised data generation device 1 generates a simulation image of the object. Then, the supervised data generation device 1 adds the position information of the object in the generated simulation image to the simulation image as annotation information, and outputs it as supervised data.

FIG. 2 is a block diagram showing the configuration of the supervised data generation system according to the first embodiment. The supervised data generation device 1 includes a shape information acquisition unit 11, an image generation condition setting unit 12, an image generation unit 13, and a supervised data output unit 14.

The supervised data generation device 1 according to the present embodiment includes, for example, a calculation unit such as a central processing unit (CPU) (not shown), and a Random Access Memory in which programs, data, etc. for controlling the supervised data generation device 1 are stored. (RAM), Read Only Memory (ROM), and other storage units. That is, the supervised data generation device 1 has a function as a computer, and executes operations described below based on the above program.

Therefore, each functional block constituting the supervised data generation device 1 shown in FIG. 2 can, in terms of hardware, be configured by the CPU, the storage unit, other circuits, or the like, and in terms of software, be realized by a program for controlling the supervised data generation device 1 stored in the storage unit or the like. That is, the supervised data generation device 1 can be realized in various forms using hardware, software, or a combination of both.

Note that the program includes a group of instructions (or software code) for causing the computer to perform one or more of the functions described in the embodiments when the program is loaded into the computer. The program may be stored on a non-transitory computer readable medium or a tangible storage medium. By way of example and not limitation, computer readable or tangible storage media may include random-access memory (RAM), read-only memory (ROM), flash memory, solid-state drive (SSD) or other memory technology, CD-ROM, including digital versatile discs (DVDs), Blu-ray discs or other optical disc storage, magnetic cassettes, magnetic tapes, magnetic disc storage or other magnetic storage devices. The program may be transmitted on a transitory computer-readable medium or a communication medium. By way of example and not limitation, transitory computer-readable or communication media includes electrical, optical, acoustic, or other forms of propagating signals.

The shape information acquisition unit 11 acquires shape information recording the shape of the object. The shape information acquisition unit 11 outputs the acquired shape information to the image generation unit 13.

Note that the shape information here may be any information as long as it is read and allows the computer to generate a three-dimensional model of the recorded object. The shape information may be, for example, information that records the shape of the object as coordinate data.

For example, the shape information may be design data of the object, such as Computer-Aided Design (CAD) data. Further, the shape information may be, for example, scan data obtained by scanning a real target object.

The shape information acquisition unit 11 may acquire the shape information of the object, for example, by reading a computer-readable medium on which shape information is recorded. Further, the shape information acquisition unit 11 may acquire the shape information of the object from the device that generated the shape information via wireless or wire. Further, the shape information acquisition unit 11 may acquire shape information of the object by receiving shape information from an external server, for example. In other words, the shape information acquisition unit 11 may have any configuration as long as it can acquire shape information of the object.

The image generation condition setting unit 12 sets image generation conditions for a simulation image of the object. The image generation condition setting unit 12 outputs the set image conditions to the image generation unit 13. Note that the image generation conditions here are conditions that define processing for converting a three-dimensional model into a two-dimensional image and image processing to be performed on the two-dimensional image.

The image generation conditions according to this embodiment include a process for converting a three-dimensional model into a two-dimensional image, such as a process for setting a depiction position of an object in a simulation image, a process for setting a depiction angle of an object, etc., processing for setting the texture of the object, processing for generating the shadow of the object, processing for setting the background of the simulation image, etc. may be defined. Further, the image generation conditions according to the present embodiment may specify, for example, blur processing, image quality conversion processing, etc. as image processing to be performed on a two-dimensional image. Note that details of each process will be described later.

The image generation condition setting unit 12 may randomly set the image generation conditions. According to such a configuration, the bias in the tendency of the supervised data output from the supervised data generation device 1 is alleviated. As a result, the recognition accuracy of image recognition system 1000 improves.

The image generation unit 13 acquires shape information from the shape information acquisition unit 11. Further, the image generation unit 13 acquires image generation conditions from the image generation condition setting unit 12. The image generation unit 13 generates a simulation image of the object based on the shape information and image generation conditions. The image generation unit 13 also generates position information of the object within the generated simulation image. The image generation unit 13 outputs the generated simulation image and position information to the supervised data output unit 14.

Here, the configuration of the image generation unit 13 will be explained in more detail. When the image generation unit 13 acquires the shape information from the shape information acquisition unit 11, it generates a three-dimensional model of the object recorded in the acquired shape information.

The three-dimensional model generated by the image generation unit 13 may be, for example, a solid model, a surface model, or a wire frame model. The three-dimensional model generated by the image generation unit 13 may be selected as appropriate depending on the processing performance of the supervised data generation device 1, the type of processing to be executed before generating the simulation image, and the like.

After generating the three-dimensional model of the object, the image generation unit 13 acquires image generation conditions from the image generation condition setting unit 12. The image generation unit 13 converts the three-dimensional model into a two-dimensional image, that is, a simulation image, based on the acquired image generation conditions.

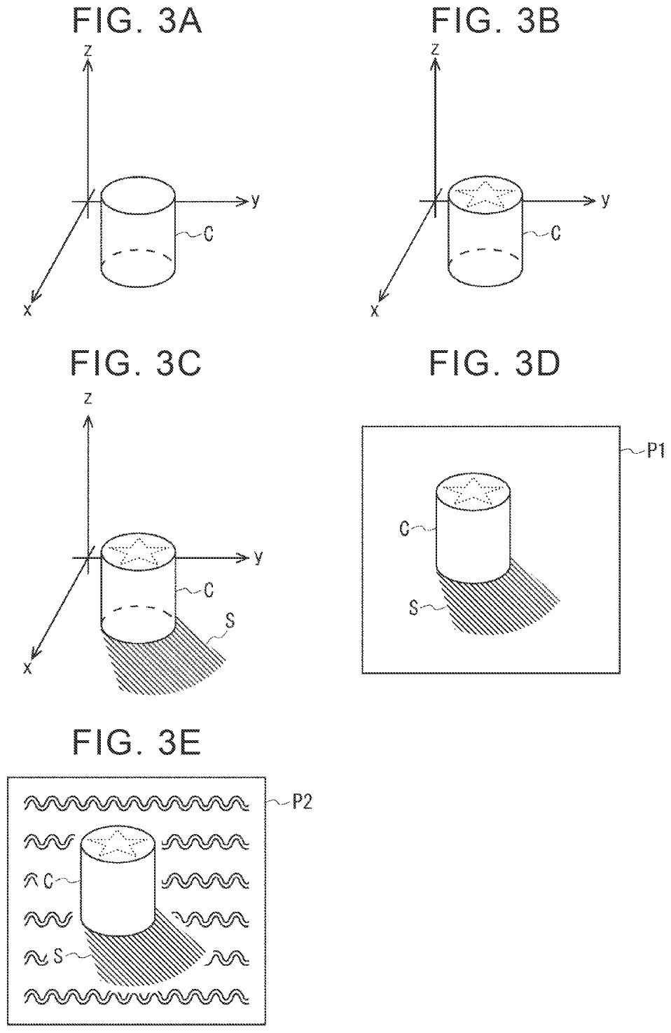

Hereinafter, the process for converting a three-dimensional model of an object into a simulation image will be described in more detail using FIGS. 3A to 3E. However, the image generation unit 13 according to the present disclosure does not need to execute all the processes described below, and may be configured to execute a part of the processes described below. Further, the image generation unit 13 according to the present disclosure does not need to execute the processes described later in the order described, and may execute them in an order different from the order described. Furthermore, some or all of the processes described below may be executed in parallel.

Upon acquiring the image generation conditions, the image generation unit 13 according to the present embodiment refers to the acquired image generation conditions and sets a texture on the surface of the three-dimensional model of the object. Note that the texture here refers to a pattern, color, etc. on the surface of a three-dimensional model of an object. That is, when the image generation unit 13 executes the process of setting the texture of the object, a pattern, a color, or both are imparted to the surface of the three-dimensional model of the object.

3A to 3E are schematic diagrams for explaining the configuration of the image generation unit according to the first embodiment. More specifically, FIG. 3A is a diagram illustrating a three-dimensional model of object C before texture is set, and FIG. 3B is a diagram illustrating a three-dimensional model of object C after texture is set. It is. That is, FIGS. 3A and 3B are diagrams illustrating the state before and after the process of setting the texture of the target object.

It should be noted that, as a matter of course, the three-dimensional models shown in FIGS. 3A and 3B are merely visualized for the purpose of simplifying the explanation, and are images realized as functional blocks of a calculation unit such as a CPU. The image generation unit 13 does not necessarily need to visualize and process the three-dimensional model of the object. The same applies to FIG. 3C, which will be described later.

FIG. 3A shows how a three-dimensional model of a cylindrical object C is generated on xyz coordinates. The surface of the three-dimensional model of the object C at the stage illustrated in FIG. 3A has no texture such as a pattern or color.

On the other hand, in FIG. 3B, a star-shaped pattern is provided on the top surface of the three-dimensional model of the cylindrical object C. In this way, by the process of setting the texture of the object C, textures such as patterns and colors are imparted to the surface of the three-dimensional model of the object C.

Note that it is preferable that the textures added to the three-dimensional model of the object C are not all the same in the plurality of simulation images generated by the supervised data generation device 1. According to such a configuration, the bias in the tendency of the texture of the object appearing in the generated simulation image is alleviated, and the recognition accuracy of the image recognition system 1000 is improved. In particular, with such a configuration, the recognition accuracy of the image recognition system 1000 for, for example, an object with dirt or the like adhered to its surface is improved.

FIG. 3C is a diagram illustrating a three-dimensional model of the object C after the process of generating the object's shadow is executed. The image generation unit 13 according to the present embodiment applies texture to the three-dimensional model of the object, and then generates a shadow of the three-dimensional model of the object with reference to the acquired image generation conditions.

The shadow of the object may be generated on the surface of a three-dimensional model of the object, or may be generated on a virtual plane on which the object is grounded. For example, in FIG. 3C, the xy plane is defined as a virtual plane on which the object C is grounded, and a shadow S is generated on the xy plane.

When the image generation unit 13 generates a shadow of a three-dimensional model of the object, the image generation condition may define, for example, the position coordinates of a point on the xyz coordinate space where the three-dimensional model of the object is generated. The image generation unit 13 may generate a shadow of the object that occurs when light is emitted from a point defined by the image generation conditions.

Note that when the shadow S of the object C is generated with the above configuration, it is preferable that the position coordinates determined by the image generation conditions are set for each simulation image. According to such a configuration, the bias in the tendency of the shadow of the object reflected in the generated simulation image is alleviated, and the recognition accuracy of the image recognition system 1000 is improved.

After generating the shadow of the three-dimensional model of the object, the image generation unit 13 according to the present embodiment executes a process of setting the depiction position and depiction angle of the object in the simulation image.

Regarding the above processing, the image generation conditions may specify, for example, position coordinates indicating a point on the xyz coordinate space where the three-dimensional model of the object is generated, and a direction vector indicating one direction on the xyz coordinate space. good. In this case, in the above process, the image generation unit 13 generates a two-dimensional image of the three-dimensional model of the object that is observed when the line of sight is directed from the point indicated by the position coordinates to the direction indicated by the direction vector. It may also be a process of outputting. In other words, the above process fixes the position and angle of the three-dimensional model of the object, and sets the virtual viewpoint position and line-of-sight angle with respect to the three-dimensional model of the object. It may also be a process of setting a depiction angle.

Furthermore, the image generation conditions for the above processing may define, for example, a matrix indicating parallel movement and rotational movement. In this case, the above process may also be a process of, the image generation unit 13 outputting, as a two-dimensional image, an image observed when the line of sight is directed from a predetermined position to the three-dimensional model of the object to which the movement indicated by the matrix is applied. In other words, the above process may be a process of setting the depiction position and depiction angle of the object in the simulation image by fixing the virtual viewpoint position and line-of-sight angle and setting the position and angle of the three-dimensional model of the object.

Note that the position of the target object in the generated simulation image is determined by the image generation unit 13 executing a process of setting the depiction position and depiction angle of the target object. Therefore, the image generation unit 13 can generate position information of the target object by executing the processing. The image generation unit 13 may output, for example, position information of the outline of the object as the position information of the object.

The image generation unit 13 according to the present embodiment executes a process of setting a background of the simulation image after executing a process of setting a depiction position and a depiction angle of the object in the simulation image. The image generation conditions for the above processing may, for example, define image data to be used as a background of a simulation image, or may define identification information of image data to be used as a background.

The image generation unit 13 according to the present embodiment may generate a simulation image of the target without a background after executing the process of setting the depiction position and depiction angle of the target in the simulation image. good. Then, the image generation unit 13 may generate a simulation image of the target with a background set by superimposing the generated simulation image of the target with no background set on the background image.

FIGS. 3D and 3E are diagrams illustrating the above processing. More specifically, FIG. 3D is a diagram of a simulation image P1 with no background set, which is generated after executing the process of setting the depiction position and depiction angle of the object in the simulation image. Further, FIG. 3E is a diagram of a simulation image P2 with a background set therein, which is generated by redundantly using the simulation image P1 shown in FIG. 3D as a background image.

For example, in FIG. 3E, a background image with wavy lines is set, but the background image can be selected as appropriate depending on the purpose of the image recognition system 1000. For example, when the image recognition system 1000 is applied only to a specific place, the image generation conditions may define an image taken at the place where the image recognition system 1000 is applied as the background image. Further, if the location where the image recognition system 1000 is applied is not specified, the image generation conditions may randomly define a background image for each simulation image to be generated.

Through the above processing, the image generation unit 13 can convert the three-dimensional model of the object into a two-dimensional image, that is, a simulation image. Further, through the above processing, position information of the object within the simulation image can be generated.

In addition to the above processing, the image generation unit 13 according to the present embodiment performs blur processing and image quality conversion processing on the generated simulation image.

When blur processing is performed on the generated simulation image, the recognition accuracy of the target object can be maintained, for example, even when viewpoint blur occurs in the photographing device 3 included in the image recognition system 1000.

Furthermore, by performing image quality conversion processing on the generated simulation image, it is possible to generate a simulation image with an image quality corresponding to the image captured by the photographing device 3 included in the image recognition system 1000, for example, thereby improving the recognition accuracy of the target object. can.

The supervised data output unit 14 acquires a simulation image of the target object and position information of the target object within the simulation image from the image generation unit 13. The supervised data output unit 14 adds positional information of the object within the simulation image to the acquired simulation image as annotation information. The supervised data output unit 14 outputs the simulation image to which annotation information has been added to the image recognition device 2.

As described above, the supervised data output unit 14 according to the present embodiment adds positional information of the object in the simulation image to the acquired simulation image as annotation information. With such a configuration, there is no need to manually add annotation information, so the supervised data generation device 1 according to the present embodiment can efficiently generate supervised data.

### Operation of Supervised Data Generation System

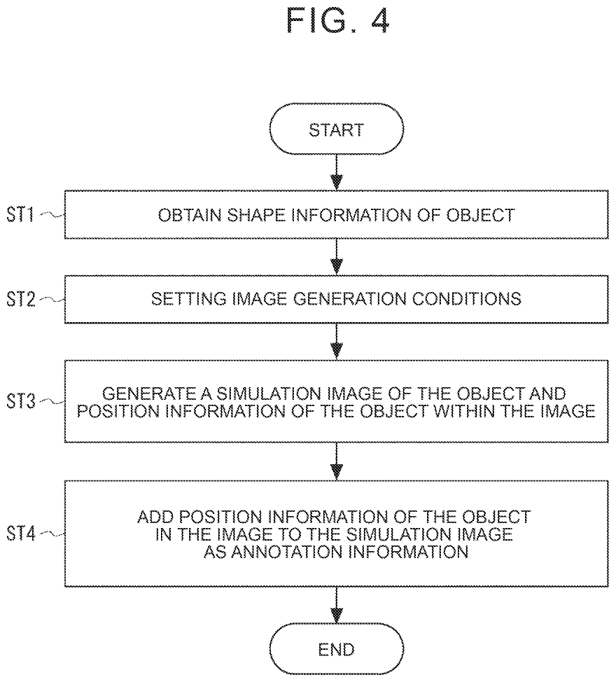

Next, the operation of the supervised data generation system, i.e., the supervised data generation method according to the first embodiment, will be explained in detail. FIG. 4 is a flowchart for explaining the operation of the supervised data generation device according to the first embodiment. In addition, in the following description, FIGS. 1 and 2 will be referred to as appropriate.

First, the shape information acquisition unit 11 acquires shape information of the object (ST1), and outputs the acquired shape information to the image generation unit 13. Next, the image generation condition setting unit 12 sets image generation conditions (ST2), and outputs the set image generation conditions to the image generation unit 13.

Next, the image generation unit 13 generates a simulation image of the object to be treated and position information of the object within the image (ST3), and outputs it to the supervised data output unit 14. Finally, the supervised data output unit 14 adds the position information of the object in the simulation image as annotation information to the simulation image (ST4), and the supervised data generation device 1 ends the series of operations. The supervised data generation device 1 repeats the operations from ST1 to ST4 to generate the amount of supervised data required by the artificial intelligence required by the image recognition device 2.

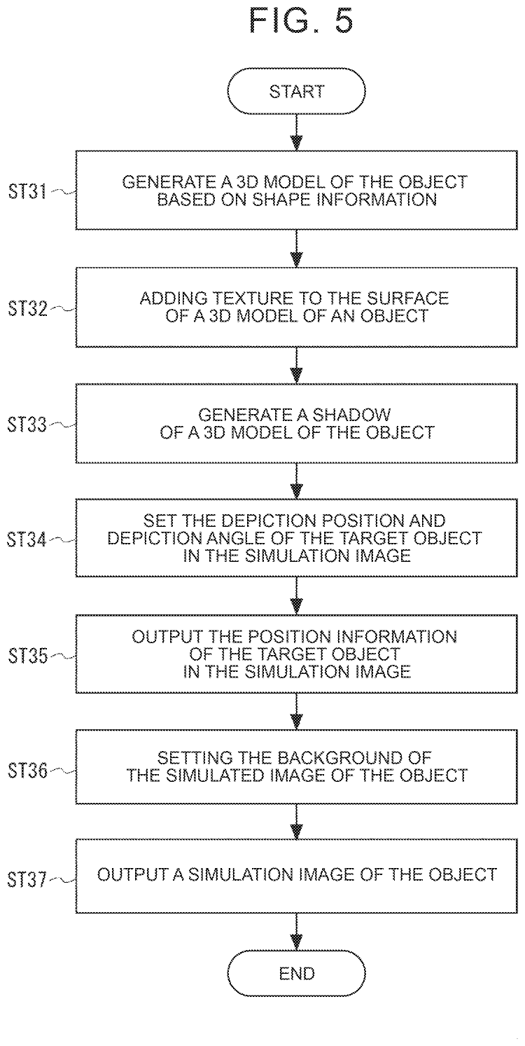

Here, ST3 will be explained in more detail. FIG. 5 is a flowchart showing the operation of the image generation unit 13. More specifically, FIG. 5 is a flowchart showing the operation performed by the image generation unit 13 in ST3.

In ST3, first, the image generation unit 13 generates a three-dimensional model of the object based on the shape information (ST31). Next, the image generation unit 13 applies texture to the surface of the three-dimensional model of the object (ST32). The image generation unit 13 applies a texture defined by image generation conditions to the surface of the three-dimensional model of the object.

Next, the image generation unit 13 generates a shadow of the three-dimensional model of the object (ST33). More specifically, the image generation unit 13 generates a shadow of the three-dimensional model of the object on the surface of the three-dimensional model of the object, on a specific plane, or both, based on the image generation conditions.

Next, the image generation unit 13 sets the depiction position and depiction angle of the target object in the simulation image (ST34). More specifically, the image generation unit 13 sets the depiction position and depiction angle of the object based on the image generation conditions.

Next, the image generation unit 13 outputs position information of the target object within the simulation image (ST35). More specifically, the image generation unit 13 outputs position information of the object in the simulation image to the supervised data output unit 14 based on the drawing position and drawing angle of the object set in ST34.

Next, the image generation unit 13 sets the background of the simulation image of the object (ST36). More specifically, the image generation unit 13 sets an image defined by the image generation conditions as the background of the simulation image of the object.

Finally, the image generation unit 13 outputs a simulation image of the object (ST37), and ST3 is completed. More specifically, the image generation unit 13 outputs a simulation image of the object to the supervised data output unit 14. Note that the image generation unit 13 may perform a step of performing blur processing, image quality conversion processing, etc. on the simulation image between ST36 and ST37.

As described above, the supervised data system according to the present embodiment generates a simulation image of the object based on the shape data of the object. Further, at the timing of generating the simulation data, position information of the object in the simulation image is generated. Then, the generated position information is added as annotation information to the simulation image and output as supervised data. With such a configuration, the musical hand data generation system according to the present embodiment can efficiently generate supervised data.

Further, the supervised data generation system according to the present embodiment performs, for example, processing for setting the texture of the object, processing for generating the shadow of the object, and setting the background of the simulation image at the timing of generating the simulation image of the object. Execute processing, etc. Further, the supervised data generation system according to the present embodiment performs blur processing, image quality conversion processing, etc. on the generated simulation image of the target object. With such a configuration, the supervised data generation system according to this embodiment can improve the accuracy of image recognition.

Part or all of the above embodiments may be described as in the following Supplementary Notes, but are not limited to the following.

### Supplementary Note 1

A shape information acquisition unit that acquires shape information recording the shape of the object; an image generation condition setting unit that sets image generation conditions for a simulation image of the object; an image generation unit that generates a simulation image of the object and position information of the object within the simulation image, based on the shape information and the image generation condition; a supervised data output unit that adds the position information as annotation information to the simulation image and outputs the simulation image; supervised data generation system.

### Supplementary Note 2

The image generation unit outputs positional information of a contour of the object in the simulation image as positional information of the object; the supervised data generation system described in Supplementary Note 1.

### Supplementary Note 3

The image generation unit sets a depiction position of the object in the simulation image based on the image generation condition; the supervised data generation system according to Supplementary Note 1 or 2.

### Supplementary Note 4

The image generation unit sets a depiction angle of the object in the simulation image based on the image generation condition; the supervised data generation system according to any one of Supplementary Notes 1 to 3.

### Supplementary Note 5

The image generation unit sets a background of the simulation image based on the image generation conditions; the supervised data generation system according to any one of Supplementary Notes 1 to 4.

### Supplementary Note 6

The image generation unit applies texture to the object in the simulation image based on the image generation condition. The supervised data generation system according to any one of Supplementary Notes 1 to 5.

### Supplementary Note 7

The image generation unit generates a shadow of the object in the simulation image based on the image generation condition; the supervised data generation system according to any one of Supplementary Notes 1 to 6.

### Supplementary Note 8

The image generation unit executes image quality conversion processing on the simulation image; the supervised data generation system according to any one of Supplementary Notes 1 to 7.

### Supplementary Note 9

The image condition performs blur processing on the simulation image; the supervised data generation system according to any one of Supplementary Notes 1 to 8.

### Supplementary Note 10

A shape information acquisition unit that acquires shape information recording the shape of the object; an image generation condition setting unit that sets image generation conditions for a simulation image of the object; an image generation unit that generates a simulation image of the object and position information of the object within the simulation image, based on the shape information and the image generation condition; a supervised data output unit that adds the position information as annotation information to the simulation image and outputs the simulation image; supervised data generation device.

### Supplementary Note 11

The computer is obtaining shape information that records the shape of the object, setting image generation conditions for a simulation image of the object; generating a simulation image of the object and position information of the object within the simulation image based on the shape information and the image generation condition; adding the position information to the simulation image as annotation information; outputting the simulation image, supervised data generation method.

Although the present disclosure has been described in accordance with the above-mentioned embodiments, the present disclosure is not limited only to the configuration of the above-mentioned embodiments, and is understood by those skilled in the art within the scope of the disclosure of the claims of the present application. It goes without saying that it includes various possible variations, modifications, and combinations.

What is claimed is:

1. A supervised data generation system comprising:
a shape information acquisition unit configured to acquire shape information indicating a record of a shape of an object;
an image generation condition setting unit configured to set an image generation condition for a simulation image of the object;
an image generation unit configured to generate the simulation image of the object and position information of the object in the simulation image based on the shape information and the image generation condition; and
a supervised data output unit configured to add the position information to the simulation image as annotation information and output the simulation image.

2. The supervised data generation system according to claim 1, wherein the image generation unit is configured to output position information of an outline of the object in the simulation image as the position information of the object.

3. The supervised data generation system according to claim 1, wherein the image generation unit is configured to set a depiction position of the object in the simulation image based on the image generation condition.

4. The supervised data generation system according to claim 1, wherein the image generation unit is configured to add texture to the object in the simulation image based on the image generation condition.

5. A supervised data generation method comprising:
acquiring, by a computer, shape information indicating a record of a shape of an object;
setting, by the computer, an image generation condition for a simulation image of the object;
generating, by the computer, the simulation image of the object and position information of the object in the simulation image based on the shape information and the image generation condition;
adding, by the computer. the position information to the simulation image as annotation information; and
outputting, by the computer, the simulation image.
